(19) United States
(12) Patent Application Publication
(10) Pub. No.: US 2024/0064761 A1
(43) Pub. Date: Feb. 22, 2024

(54) METHOD FOR TRANSMISSION CONFIGURATION INDICATOR STATE DETERMINATION, TERMINAL DEVICE, AND NON-TRANSITORY COMPUTER-READABLE STORAGE MEDIUM

(71) Applicant: SPREADTRUM SEMICONDUCTOR (NANJING) CO.,LTD., Nanjing, Jiangsu (CN)

(72) Inventor: Yuhua WANG, Nanjing, Jiangsu (CN)

(21) Appl. No.: 18/260,331

(22) PCT Filed: Jan. 27, 2022
(86) PCT No.: PCT/CN2022/074318

§ 371 Date: Jul. 4, 2023

(30) Foreign Application Priority Data
Jan. 5, 2021 (CN) 202110010491.8

(51) Int. Cl. H04W 72/231; H04L 5/00

(52) U.S. Cl. CPC H04W 72/231; H04L 5/0053; H04L 5/0048

(57) ABSTRACT

A method for transmission configuration indicator (TCI) state determination is provided. The method includes the following. Receive higher-layer configuration information. Determine N control resource sets (CORESETs) and at least one TCI state of each of the N CORESETs based on the higher-layer configuration information. Determine a target CORESET from the N CORESETs; and determine a target TCI state from at least one TCI state of the target CORESET.

### CROSS-REFERENCE TO RELATED APPLICATION(S)

This application is a National Stage of International Application No. PCT/CN2022/074318, filed on Jan. 27, 2022, which claims priority to Chinese Patent Application No. 202110010491.8, filed on Jan. 5, 2021, both of which are incorporated herein by reference in their entireties.

### TECHNICAL FIELD

This disclosure relates to the technical field of communication, and in particular, to a method for transmission configuration indicator (TCI) state determination, a terminal device, and a non-transitory computer-readable storage medium.

### BACKGROUND

In current new radio (NR) technologies, a terminal device can determine a control resource set (CORESET) based on higher-layer signaling transmitted by a network device to determine a unique transmission configuration indicator (TCI) state. Furthermore, the terminal device can determine, according to the unique TCI state, at least one of: a beam for channel transmission, a beam for reference signal (RS) transmission, a path loss reference signal (PL-RS) for calculating a PL, or a quasi co-location (QCL) assumption.

However, in a multiple-transmission and reception point (multi-TRP) transmission scenario in the 3rd generation partnership project (3GPP) release (Rel) 17, the terminal device can obtain multiple CORESETs based on higher-layer information, and each CORESET may have multiple TCI states. Therefore, it is difficult for the terminal device to determine, according to the multiple TCI states, at least one of: a beam for channel transmission, a beam for RS transmission, a PL-RS for calculating a PL, a PL-RS for RS transmission, a QCL assumption for channel transmission, or a QCL assumption for RS transmission, thereby adversely affecting information interaction between the terminal device and the network device. Therefore, how to determine, among the multiple TCI states, a TCI state for determining a beam, a PL-RS, and/or a QCL assumption is a key problem to-be-solved.

### SUMMARY

A method for transmission configuration indicator (TCI) state determination, a terminal device, and a non-transitory computer-readable storage medium are provided in implementations of the disclosure.

In a first aspect, a method for TCI state determination is provided in implementations of the disclosure. The method includes the following. Receive higher-layer configuration information. Determine N CORESETs and at least one TCI state of each of the N CORESETs based on the higher-layer configuration information, where N is a positive integer. Determine a target CORESET from the N CORESETs. Determine a target TCI state from at least one TCI state of the target CORESET.

In a second aspect, a terminal device is provided in implementations of the disclosure. The terminal device includes a communication interface, a processor coupled to the communication interface, and a memory configured to store a computer program. The processor is configured to execute the computer program to cause the terminal device to receive higher-layer configuration information; determine N CORESETs and at least one TCI state of each of the N CORESETs based on the higher-layer configuration information, where N is a positive integer; determine a target CORESET from the N CORESETs; and determine a target TCI state from at least one TCI state of the target CORESET.

In a third aspect, a non-transitory computer-readable storage medium is provided in implementations of the disclosure. The storage medium stores a computer program. The computer program is executed by a processor of a terminal device to cause the terminal device to perform the following. Receive higher-layer configuration information. Determine N CORESETs and at least one TCI state of each of the N CORESETs based on the higher-layer configuration information, where N is a positive integer. Determine a target CORESET from the N CORESETs. Determine a target TCI state from at least one TCI state of the target CORESET.

### BRIEF DESCRIPTION OF THE DRAWINGS

In order to describe technical solutions in implementations of the disclosure or in the related art more clearly, the following will give a brief introduction to accompanying drawings required for describing implementations or the related art. Apparently, the accompanying drawings hereinafter described merely illustrate some implementations of the disclosure. Based on these drawings, those of ordinary skills in the art can also obtain other drawings without creative effort.

FIG. 1 is a schematic flow chart illustrating a method for transmission configuration indicator (TCI) state determination provided in implementations of the disclosure.

FIG. 2 is a schematic structural view of a terminal device provided in implementations of the disclosure.

FIG. 3 is a schematic structural view of a network device provided in implementations of the disclosure.

FIG. 4 is a schematic structural view of an apparatus for TCI state determination provided in implementations of the disclosure.

FIG. 5 is another schematic structural view of an apparatus for TCI state determination provided in implementations of the disclosure.

### DETAILED DESCRIPTION

The terms used in implementations of the disclosure are for the purpose of explaining specific implementations of the disclosure only and are not intended to limit the disclosure. The terms “first”, “second”, “third”, “fourth” and the like used in the specification, the claims, and the accompany drawings of the disclosure are used to distinguish different objects rather than describe a particular order. The terms “include”, “comprise”, and “have” as well as variations thereof are intended to cover non-exclusive inclusion.

The terminal device in implementations of the disclosure may be a device with wireless communication functions and deployed on land, including indoor or outdoor, handheld, wearable, or vehicle-mounted; on water (e.g., a ship); and also in the air (e.g., aircraft, balloons, and satellites). The terminal device may be a mobile phone, a pad, a computer with wireless receiving and transmitting functions, a terminal device for virtual reality (VR), a terminal device for augmented reality (AR), a wireless terminal in industrial control, a wireless terminal in self driving, a wireless terminal in remote medical, a wireless terminal in smart grid, a wireless terminal in smart home, or the like. The terminal device may also be a device with wireless communication functions such as a handheld device, an in-vehicle device, a wearable device, a computing device, or other processing devices coupled with a wireless modem.

The network device in implementations of the disclosure is a device deployed in the radio access network to provide wireless communication function. For example, a device providing a base station function in a second-generation (2G) network includes a base transceiver station (BTS). A device providing a base station function in a third-generation (3G) network includes a NodeB. A device providing a base station function in a fourth-generation (4G) network includes an evolved NodeB (eNB). In a wireless local area network (WLAN), a device providing a base station function is an access point (AP). In a fifth-generation (5G) new radio (NR), a device providing a base station function includes a gNB and a further evolved ng-eNB. The gNB can communicate with a terminal device through NR technology, the ng-eNB can communicate with the terminal communicate through evolved universal terrestrial radio access (E-UTRA) technology, and both the gNB and the ng-eNB can be connected to a 5G core network. The base station in implementations of the disclosure may further include a device providing a base station function in a future new communication system, and the like.

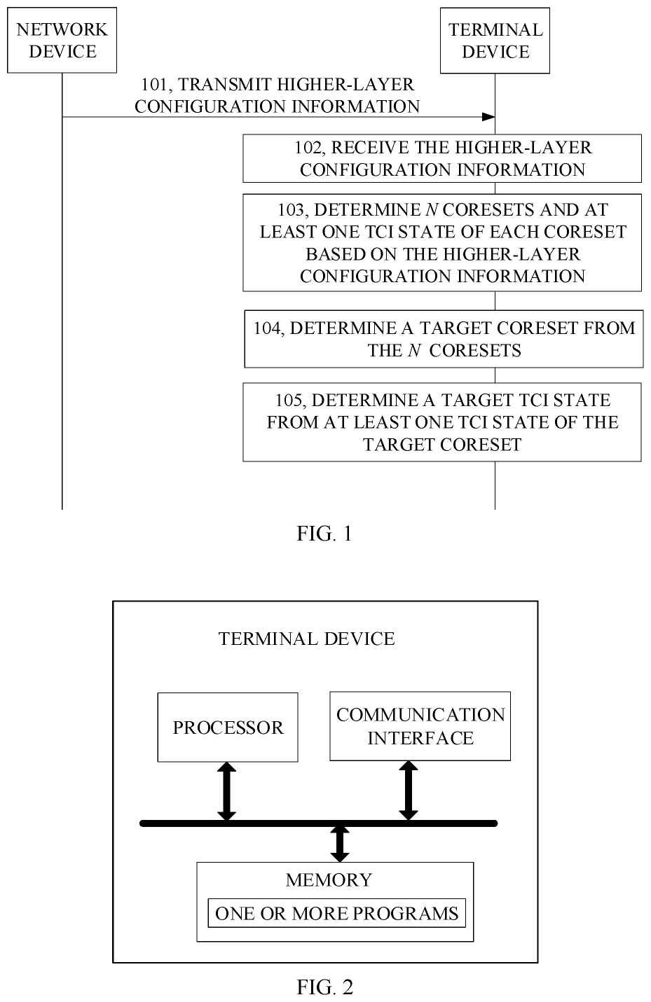

Referring to FIG. 1, FIG. 1 is a schematic flow chart illustrating a method for transmission configuration indicator (TCI) state determination provided in implementations of the disclosure. The method is applicable to the above network device and the terminal device. The method includes the following.

At 101, the network device transmits higher-layer configuration information.

Before the network device transmits a physical downlink control channel (PDCCH) to the terminal device, the network device needs to first transmit to the terminal device the higher-layer configuration information, i.e., CORESETs and configuration information for the CORESETs (the CORESETs are in one-to-one correspondence with the configuration information for the CORESETs, and configuration information for each CORESET includes at least one TCI state), so that the terminal device can know a resource and a TCI state that are required for PDCCH reception.

The configuration information for each CORESET may include one TCI state, two TCI states, at least two TCI states, etc.

At 102, the terminal device receives the higher-layer configuration information.

At 103, the terminal device determines N CORESETs and at least one TCI state of each CORESET based on the higher-layer configuration information.

Information for the N CORESETs on a current active bandwidth part (BWP) can be determined based on the higher-layer configuration information. A radio resource control (RRC) layer can configure multiple TCI states for each CORESET, and at least one TCI state can be activated via a medium access control control element (MAC CE).

CORESETs can be distinguished from each other via CORESET identifiers (IDs), and TCI states can be distinguished from each other via TCI state IDs.

The CORESET ID is unique, and the TCI state ID is unique.

Each TCI state is associated with a corresponding TCI state ID, and each CORESET is associated with a corresponding CORESET ID.

At 104, the terminal device determines a target CORESET from the N CORESETs.

The target COERSET may be predefined or determined according to a preset rule.

At 105, the terminal device determines a target TCI state from at least one TCI state of the target CORESET.

It can be seen that in implementations of the disclosure, the terminal device first receives the higher-layer configuration information, then determines the N CORESETs and the at least one TCI state of each CORESET based on the higher-layer configuration information, then determines the target CORESET from the N CORESETs, and finally determines the target TCI state from the at least one TCI state of the target CORESET. Since the target TCI state is used for determining a path loss reference signal (PL-RS), a beam, and/or quasi co-location (QCL) assumption, the terminal device can determine, according to multiple TCI states of a CORESET, at least one of: a beam for channel transmission, a beam for RS transmission, a PL-RS for calculating a PL, a PL-RS for RS transmission, a QCL assumption for channel transmission, or a QCL assumption for RS transmission, thereby facilitating normal information interaction between the terminal device and the network device.

In a possible implementation, the target TCI state is used for determining a target QCL assumption.

The target TCI state is default.

In a possible implementation, the target QCL assumption is used for aperiodic channel state information-reference signal (AP CSI-RS) transmission and/or for physical downlink shared channel (PDSCH) transmission.

AP CSI-RS transmission and/or PDSCH transmission can be performed with the target QCL assumption upon satisfying at least one of: a higher layer configuring no TCI state for CSI-RS transmission and/or PDSCH transmission; or the number (quantity) of symbols from a last symbol of a PDCCH scheduling a CSI-RS and/or a PDSCH to a first symbol of an AP CSI-RS and/or the PDSCH being less than a threshold (the threshold may be reported by the terminal device, or configured by the network device according to a capability of the terminal device).

In a possible implementation, the target TCI state is used for determining a PL-RS and/or a beam.

In an implementation of the disclosure, the beam includes at least one of: a beam for physical uplink control channel (PUCCH) transmission, a beam for physical uplink shared channel (PUSCH) transmission, a beam for sounding reference signal (SRS) transmission, a beam for AP CSI-RS transmission, or a beam for PDSCH transmission.

The beam for PUCCH transmission, the beam for PUSCH transmission, the beam for SRS transmission, the beam for CSI-RS transmission, and the beam for PDSCH transmission are different from each other.

The beam is in the target TCI state on condition that the beam is default.

The beam for channel transmission and/or the beam for RS transmission are default beams upon satisfying at least one of: for a downlink (DL) channel and a reference signal, the higher-layer configuring no beam information for CSI-RS transmission and/or PDSCH transmission; or the number of symbols from the last symbol of the PDCCH scheduling the CSI-RS and/or the PDSCH to the first symbol of the AP CSI-RS and/or the PDSCH being less than the threshold (the threshold may be reported by the terminal device, or configured by the network device according to a capability of the terminal device). The target TCI state is used for determining beam information for CSI-RS transmission and/or PDSCH transmission. For a PUCCH, a higher-layer parameter includes no PUCCH-SpatialRelationInfo and includes enableDefaultBeamPL-ForPUCCH-r16. For a PUSCH, a higher-layer parameter includes enableDefaultBeamPL-ForPUSCH0-r16, no PUCCH transmission resource is configured on the current active BWP, or PUCCH resources are configured on the current active BWP but no PUCCH-SpatialRelationInfo is configured, and current PUSCH transmission is scheduled by DCI 0_0. For an SRS, a higher-layer parameter is configured with enableDefaultBeamPL-ForSRS-r16, and a higher-layer parameter corresponding to an SRS resource includes no spatialRelationInfo and is configured with no pathlossReferenceRS or SRS-PathlossReferenceRS. A higher-layer parameter includes enableDefaultBeamPL-ForPUCCH-r16, enableDefaultBeamPL-ForPUSCH0-r16, or enableDefaultBeamPL-ForSRS-r16 as follows. The higher-layer parameter may be directly configured with enableDefaultBeamPL-ForPUCCH-r16, enableDefaultBeamPL-ForPUSCH0-r16, or enableDefaultBeamPL-SRS-ForPUSCH0-r16. Alternatively, in the higher-layer parameter, enableDefaultBeamPL-ForPUCCH-r16, enableDefaultBeamPL-ForPUSCH0-r16, or enableDefaultBeamPL-ForSRS-r16 may be set to be “enabled”.

A beam for transmission of a reference signal resource with “QCL-Type D” in the TCI state may be determined as a beam for PUCCH/PUSCH/SRS/AP CSI-RS/PDSCH transmission.

In an implementation of the disclosure, the PL-RS includes at least one of: a PL-RS for determining a PL of PUCCH transmission power, a PL-RS for determining a PL of PUSCH transmission power, or a PL-RS for determining a PL of SRS transmission power.

The PUCCH transmission power, the PUSCH transmission power, and the SRS transmission power are different from each other. For example, the PUCCH transmission power is the same as the PUSCH transmission power, and the PUCCH transmission power is different from the SRS transmission power. For another example, the PUCCH transmission power is different from the PUSCH transmission power, and the PUCCH transmission power is the same as the SRS transmission power, which is not limited herein.

The PL-RS for determining a PL of PUCCH transmission power, the PL-RS for determining a PL of PUSCH transmission power, and the PL-RS for determining a PL of SRS transmission power may be different from each other.

In the case that the PL-RS is default, a period RS resource with “QCL-Type D” in the TCI state is determined as a PL-RS resource.

The PL-RS for channel transmission and/or the PL-RS for RS transmission are default upon satisfying the following. For SRS transmission, a higher-layer parameter includes enableDefaultBeamPL-ForSRS-r16, is configured with no pathlossReferenceRS or no SRS-PathlossReferenceRS, and is configured with no spatialrelationInfo. For PUSCH transmission, a higher-layer parameter includes enableDefaultBeamPL-ForSUPHO-r16, no PUCCH transmission resource is configured on the current active BWP, or PUCCH resources are configured on the current active BWP but no PUCCH-SpatialRelationInfo is configured, and current PUSCH transmission is scheduled by DCI 0_0. For PUCCH transmission, a higher-layer parameter includes enableDefaultBeamPL-ForPUCCH-r16 but includes no pathlossReferenceRS and no PUCCH-SpatialRelationInfo.

The higher-layer parameter includes enableDefaultBeamPL-ForPUCCH-r16, enableDefaultBeamPL-ForPUSCH0-r16, or enableDefaultBeamPL-ForSRS-r16 as follows. The higher-layer parameter may be directly configured with enableDefaultBeamPL-ForPUCCH-r16, enableDefaultBeamPL-ForPUSCH0-r16, or enableDefaultBeamPL-SRS-ForPUSCH0-r16.

Alternatively, in the higher-layer parameter, enableDefaultBeamPL-ForPUCCH-r16, enableDefaultBeamPL-ForPUSCH0-r16, or enableDefaultBeamPL-ForSRS-r16 may be set to be “enabled”.

In an implementation of the disclosure, the target CORESET is a CORESET with a lowest CORESET ID among the N CORESETs.

For example, on condition that there are three CORESETs (CORESET #0, CORESET #1, and CORESET #2), where an ID of the CORESET #0 is 1, an ID of the CORESET #1 is 3, and an ID of the CORESET #2 is 8, the CORESET #0 is referred to as the target CORESET.

In an implementation of the disclosure, the target CORESET has at least two TCI states.

In an implementation of the disclosure, the target TCI state is a first TCI state among the at least two TCI states of the target CORESET; the target TCI state is a last TCI state among the at least two TCI states of the target CORESET; the target TCI state is a TCI state with a lowest TCI state ID among the at least two TCI states of the target CORESET; or the target TCI state is a TCI state with a highest TCI state ID among the at least two TCI states of the target CORESET.

The higher-layer configuration information may further include a TCI state ID of each TCI state, and each TCI state is associated with a corresponding TCI state ID.

For example, the target CORESET has two TCI states (TCI state #0 and TCI state #1), where an ID of the TCI state #0 is 7, an ID of the TCI state #1 is 2, the TCI state #0 is referred to as a first TCI state of the target CORESET, and the TCI state #1 is referred to as a second TCI state of the target CORESET. Therefore, on condition that the first TCI state of the target CORESET is referred to as the target TCI state, the target TCI state is the TCI state #0. On condition that a last TCI state of the target CORESET is referred to as the target TCI state, the target TCI state is the TCI state #1. For the target CORESET, on condition that a TCI state with a lowest TCI state ID is referred to as the target TCI state, the target TCI state is the TCI state #1. For the target CORESET, on condition that a TCI state with a highest TCI state ID is referred to as the target TCI state, the target TCI state is the TCI state #0.

The target TCI state may be determined in multiple pre-configured manners, thereby improving flexibility of TCI state determination.

In an implementation of the disclosure, the target CORESET is a CORESET with a lowest CORESET ID among M reference CORESETs, each of the reference CORESETs is a CORESET with one TCI state among the N CORESETs, and M is a positive integer and less than or equal to N.

Among the N CORESETs, each of CORESETs other than the M reference CORESETs has at least two TCI states.

For example, on condition that there are three CORESETs (CORESET #0, CORESET #1, and CORESET #2), an ID of the CORESET #0 is 3, an ID of the CORESET #1 is 5, an ID of the CORESET #2 is 7, the CORESET #0 has two TCI states, and each of the CORESET #1 and the CORESET #2 has one TCI state, the CORESET #1 and the CORESET #2 are referred to as reference CORESETs. Since the ID of the CORESET #1 is less than the ID of the CORESET #2, the CORESET #1 is referred to as the target CORESET, and the TCI state of the CORESET #1 is referred to as the target TCI state.

In an implementation of the disclosure, the target QCL assumption is used for transmitting a PDCCH candidate.

The terminal device can receive the PDCCH candidate according to the target QCL assumption.

In an implementation of the disclosure, the target CORESET is a CORESET corresponding to the PDCCH candidate among the N CORESETs.

Search-space-set configuration information for the PDCCH candidate is determined based on the higher-layer configuration information, and target CORESET information is determined based on the search-space-set configuration information.

Based on the higher-layer configuration information, it is determined that the PDCCH candidate corresponds to one TCI state.

A CORESET and a search space set are configured by a higher layer. The target CORESET is a CORESET associated with the search space set among the N CORESETs. The PDCCH candidate can be transmitted based on the search space set associated with the target CORESET. The terminal device can monitor the PDCCH candidate based on the search space set associated.

In an implementation of the disclosure, the target CORESET has at least two TCI states.

In an implementation of the disclosure, the target TCI state is a first TCI state among the at least two TCI states of the target CORESET; the target TCI state is a last TCI state among the at least two TCI states of the target CORESET; the target TCI state is a TCI state with a lowest TCI state ID among the at least two TCI states of the target CORESET; or the target TCI state is a TCI state with a highest TCI state ID among the at least two TCI states of the target CORESET.

For example, the target CORESET has two TCI states (TCI state #0 and TCI state #1), where an ID of the TCI state #0 is 7, an ID of the TCI state #1 is 2, the TCI state #0 is referred to as a first TCI state of the target CORESET, and the TCI state #1 is referred to as a second TCI state of the target CORESET. Therefore, on condition that the first TCI state of the target CORESET is referred to as the target TCI state, the target TCI state is the TCI state #0. On condition that a last TCI state of the target CORESET is referred to as the target TCI state, the target TCI state is the TCI state #1. For the target CORESET, on condition that a TCI state with a lowest TCI state ID is referred to as the target TCI state, the target TCI state is the TCI state #1. For the target CORESET, on condition that a TCI state with a highest TCI state ID is referred to as the target TCI state, the target TCI state is the TCI state #0.

The target TCI state may be determined in multiple pre-configured manners, thereby improving flexibility of TCI state determination.

Referring to FIG. 2, FIG. 2 is a schematic structural view of a terminal device provided in implementations of the disclosure. The terminal device includes one or more processors, one or more memories, one or more communication interfaces, and one or more programs. The one or more programs are stored in the memory and configured to be executed by the one or more processors. The programs include instructions for performing the following. Receive higher-layer configuration information. Determine N CORESETs and at least one TCI state of each of the N CORESETs based on the higher-layer configuration information, where N is a positive integer. Determine a target CORESET from the N CORESETs. Determine a target TCI state from at least one TCI state of the target CORESET.

In an implementation of the disclosure, the target TCI state is used for determining a target QCL assumption.

In an implementation of the disclosure, the target QCL assumption is used for AP CSI-RS transmission and/or for PDSCH transmission.

In an implementation of the disclosure, the target TCI state is used for determining a PL-RS and/or a beam.

In an implementation of the disclosure, the beam includes at least one of: a beam for PUCCH transmission, a beam for PUSCH transmission, a beam for SRS transmission, a beam for AP CSI-RS transmission, or a beam for PDSCH transmission.

In an implementation of the disclosure, the PL-RS includes at least one of: a PL-RS for determining a PL of PUCCH transmission power, a PL-RS for determining a PL of PUSCH transmission power, or a PL-RS for determining a PL of SRS transmission power.

In an implementation of the disclosure, the target CORESET is a CORESET with a lowest CORESET ID among the N CORESETs.

In an implementation of the disclosure, the target CORESET has at least two TCI states.

In an implementation of the disclosure, the target TCI state is a first TCI state among the at least two TCI states of the target CORESET; the target TCI state is a last TCI state among the at least two TCI states of the target CORESET; the target TCI state is a TCI state with a lowest TCI state ID among the at least two TCI states of the target CORESET; or the target TCI state is a TCI state with a highest TCI state ID among the at least two TCI states of the target CORESET.

In an implementation of the disclosure, the target CORESET is a CORESET with a lowest CORESET ID among M reference CORESETs. Each of the reference CORESETs is a CORESET with one TCI state among the N CORESETs, and M is a positive integer and less than or equal to N.

In an implementation of the disclosure, the target QCL assumption is used for transmitting a PDCCH candidate.

In an implementation of the disclosure, the target CORESET is a CORESET corresponding to the PDCCH candidate among the N CORESETs.

In an implementation of the disclosure, the target CORESET has at least two TCI states.

In an implementation of the disclosure, the target TCI state is a first TCI state among the at least two TCI states of the target CORESET; the target TCI state is a last TCI state among the at least two TCI states of the target CORESET; the target TCI state is a TCI state with a lowest TCI state ID among the at least two TCI states of the target CORESET; or the target TCI state is a TCI state with a highest TCI state ID among the at least two TCI states of the target CORESET.

It needs to be noted that, for a specific implementation process of this implementation, reference may be made to the specific implementation process in the foregoing method implementation, which will not be described herein.

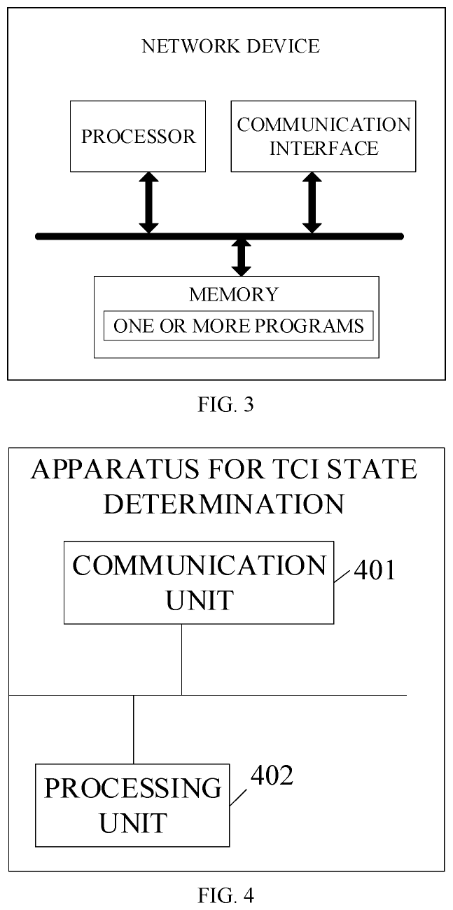

Referring to FIG. 3, FIG. 3 is a schematic structural view of a network device provided in implementations of the disclosure. The network device includes one or more processors, one or more memories, one or more communication interfaces, and one or more programs. The one or more programs are stored in the memory and configured to be executed by the one or more processors. The programs include instructions for performing the following. Transmit higher-layer configuration information. The higher-layer configuration information is used for a terminal device to determine N CORESETs and at least one TCI state of each of the N CORESETs. The N CORESETs include a target CORESET. The target CORESET is used for the terminal device to determine a target TCI state from at least one TCI state of the target CORESET. N is a positive integer.

In an implementation of the disclosure, the target TCI state is used for determining a target QCL assumption.

In an implementation of the disclosure, the target QCL assumption is used for AP CSI-RS transmission and/or for PDSCH transmission.

In an implementation of the disclosure, the target TCI state is used for determining a PL-RS and/or a beam.

In an implementation of the disclosure, the higher-layer configuration information further includes a CORESET ID of each CORESET and a TCI state ID of each TCI state corresponding to each CORESET.

In an implementation of the disclosure, the beam includes at least one of: a beam for PUCCH transmission, a beam for PUSCH transmission, a beam for SRS transmission, a beam for AP CSI-RS transmission, or a beam for PDSCH transmission.

In an implementation of the disclosure, the PL-RS includes at least one of: a PL-RS for determining a PL of PUCCH transmission power, a PL-RS for determining a PL of PUSCH transmission power, or a PL-RS for determining a PL of SRS transmission power.

In an implementation of the disclosure, the target CORESET is a CORESET with a lowest CORESET ID among the N CORESETs.

In an implementation of the disclosure, the target CORESET has at least two TCI states.

In an implementation of the disclosure, the target TCI state is a first TCI state among the at least two TCI states of the target CORESET; the target TCI state is a last TCI state among the at least two TCI states of the target CORESET; the target TCI state is a TCI state with a lowest TCI state ID among the at least two TCI states of the target CORESET; or the target TCI state is a TCI state with a highest TCI state ID among the at least two TCI states of the target CORESET.

In an implementation of the disclosure, the target CORESET is a CORESET with a lowest CORESET ID among M reference CORESETs. Each of the reference CORESETs is a CORESET with one TCI state among the N CORESETs, and M is a positive integer and less than or equal to N.

In an implementation of the disclosure, the target QCL assumption is used for transmitting a PDCCH candidate.

In an implementation of the disclosure, the target CORESET is a CORESET corresponding to the PDCCH candidate among the N CORESETs.

In an implementation of the disclosure, the target CORESET has at least two TCI states.

In an implementation of the disclosure, the target TCI state is a first TCI state among the at least two TCI states of the target CORESET; the target TCI state is a last TCI state among the at least two TCI states of the target CORESET; the target TCI state is a TCI state with a lowest TCI state ID among the at least two TCI states of the target CORESET; or the target TCI state is a TCI state with a highest TCI state ID among the at least two TCI states of the target CORESET.

It needs to be noted that, for a specific implementation process of this implementation, reference may be made to the specific implementation process in the foregoing method implementation, which will not be described herein.

Referring to FIG. 4, FIG. 4 is a schematic structural view of an apparatus for TCI state determination provided in implementations of the disclosure. The apparatus may be, for example, a chip, a chip module, an integrated circuit, or a terminal device, which is not limited herein. The apparatus includes a communication unit 401 and a processing unit 402. The communication unit 401 is configured to receive higher-layer configuration information. The processing unit 402 is configured to determine N CORESETs and at least one TCI state of each of the N CORESETs based on the higher-layer configuration information, where N is a positive integer. The processing unit 402 is further configured to determine a target CORESET from the N CORESETs. The processing unit 402 is further configured to determine a target TCI state from at least one TCI state of the target CORESET.

In an implementation of the disclosure, the target TCI state is used for determining a target QCL assumption.

In an implementation of the disclosure, the target QCL assumption is used for AP CSI-RS transmission and/or for PDSCH transmission.

In an implementation of the disclosure, the target TCI state is used for determining a PL-RS and/or a beam.

In an implementation of the disclosure, the beam includes at least one of: a beam for PUCCH transmission, a beam for PUSCH transmission, a beam for SRS transmission, a beam for AP CSI-RS transmission, or a beam for PDSCH transmission.

In an implementation of the disclosure, the PL-RS includes at least one of: a PL-RS for determining a PL of PUCCH transmission power, a PL-RS for determining a PL of PUSCH transmission power, or a PL-RS for determining a PL of SRS transmission power.

In an implementation of the disclosure, the target CORESET is a CORESET with a lowest CORESET ID among the N CORESETs.

In an implementation of the disclosure, the target CORESET has at least two TCI states.

In an implementation of the disclosure, the target TCI state is a first TCI state among the at least two TCI states of the target CORESET; the target TCI state is a last TCI state among the at least two TCI states of the target CORESET; the target TCI state is a TCI state with a lowest TCI state ID among the at least two TCI states of the target CORESET; or the target TCI state is a TCI state with a highest TCI state ID among the at least two TCI states of the target CORESET.

In an implementation of the disclosure, the target CORESET is a CORESET with a lowest CORESET ID among M reference CORESETs. Each of the reference CORESETs is a CORESET with one TCI state among the N CORESETs, and M is a positive integer and less than or equal to N.

In an implementation of the disclosure, the target QCL assumption is used for transmitting a PDCCH candidate.

In an implementation of the disclosure, the target CORESET is a CORESET corresponding to the PDCCH candidate among the N CORESETs.

In an implementation of the disclosure, the target CORESET has at least two TCI states.

In an implementation of the disclosure, the target TCI state is a first TCI state among the at least two TCI states of the target CORESET; the target TCI state is a last TCI state among the at least two TCI states of the target CORESET; the target TCI state is a TCI state with a lowest TCI state ID among the at least two TCI states of the target CORESET; or the target TCI state is a TCI state with a highest TCI state ID among the at least two TCI states of the target CORESET.

It needs to be noted that, the communication unit 401 in the apparatus may be implemented through a communication interface, and the processing unit 402 may be implemented through a processor.

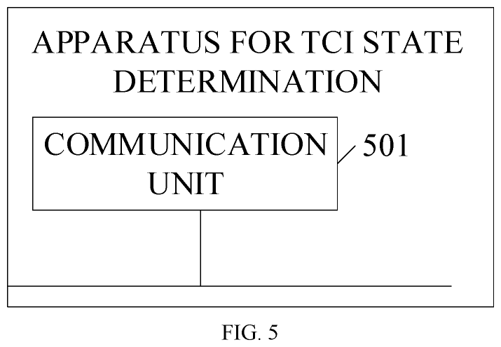

Referring to FIG. 5, FIG. 5 is another schematic structural view of an apparatus for TCI state determination provided in implementations of the disclosure. The apparatus may be, for example, a chip, a chip module, an integrated circuit, or a network device, which is not limited herein. The apparatus includes a communication unit 501. The communication unit 501 is configured to transmit higher-layer configuration information. The higher-layer configuration information is used for a terminal device to determine N CORESETs and at least one TCI state of each of the N CORESETs. The N CORESETs include a target CORESET. The target CORESET is used for the terminal device to determine a target TCI state from at least one TCI state of the target CORESET. N is a positive integer.

In an implementation of the disclosure, the target TCI state is used for determining a target QCL assumption.

In an implementation of the disclosure, the target QCL assumption is used for AP CSI-RS transmission and/or for PDSCH transmission.

In an implementation of the disclosure, the target TCI state is used for determining a PL-RS and/or a beam.

In an implementation of the disclosure, the beam includes at least one of: a beam for PUCCH transmission, a beam for PUSCH transmission, a beam for SRS transmission, a beam for AP CSI-RS transmission, or a beam for PDSCH transmission.

In an implementation of the disclosure, the PL-RS includes at least one of: a PL-RS for determining a PL of PUCCH transmission power, a PL-RS for determining a PL of PUSCH transmission power, or a PL-RS for determining a PL of SRS transmission power.

In an implementation of the disclosure, the target CORESET is a CORESET with a lowest CORESET ID among the N CORESETs.

In an implementation of the disclosure, the target CORESET has at least two TCI states.

In an implementation of the disclosure, the target TCI state is a first TCI state among the at least two TCI states of the target CORESET; the target TCI state is a last TCI state among the at least two TCI states of the target CORESET; the target TCI state is a TCI state with a lowest TCI state ID among the at least two TCI states of the target CORESET; or the target TCI state is a TCI state with a highest TCI state ID among the at least two TCI states of the target CORESET.

In an implementation of the disclosure, the target CORESET is a CORESET with a lowest CORESET ID among M reference CORESETs. Each of the reference CORESETs is a CORESET with one TCI state among the N CORESETs, and M is a positive integer and less than or equal to N.

In an implementation of the disclosure, the target QCL assumption is used for transmitting a PDCCH candidate.

In an implementation of the disclosure, the target CORESET is a CORESET corresponding to the PDCCH candidate among the N CORESETs.

In an implementation of the disclosure, the target CORESET has at least two TCI states.

In an implementation of the disclosure, the target TCI state is a first TCI state among the at least two TCI states of the target CORESET; the target TCI state is a last TCI state among the at least two TCI states of the target CORESET; the target TCI state is a TCI state with a lowest TCI state ID among the at least two TCI states of the target CORESET; or the target TCI state is a TCI state with a highest TCI state ID among the at least two TCI states of the target CORESET.

It needs to be noted that, the communication unit 501 in the apparatus may be implemented through a communication interface.

Each module/unit in the apparatuses or products described in the foregoing implementations may be a software module/unit, a hardware module/unit, or may be partially a software module/unit and partially a hardware module/unit. For example, for each apparatus and product applied to or integrated into the chip, each module/unit included can be implemented by hardware such as circuits, or at least part of modules/units can be implemented by software programs that run on a processor integrated into the chip, and the rest of (if any) modules/units can be implemented by hardware such as circuits. For each apparatus and product applied to or integrated into the chip module, each module/unit included can be implemented by hardware such as circuit, and different modules/units can be located in a same component (such as a chip, a circuit module, etc.) or different components of the chip module. Alternatively, at least part of modules/units can be implemented by software programs that run on the processor integrated into the chip module, and the rest of (if any) modules/units can be implemented by hardware such as circuits. For each apparatus and product applied to or integrated into the terminal device, each module/unit included can be implemented by hardware such as circuits, and different modules/units can be located in a same component (e.g., a chip, a circuit module, etc.) or different components in the terminal device, or at least part of modules/units can be implemented by software programs that run on the processor integrated into the terminal device, and the rest of (if any) modules/units can be implemented by hardware such as circuits.

A computer storage medium is further provided in implementations of the disclosure. The computer storage medium stores computer programs for electronic data interchange. The computer programs enable a computer to perform part or all of the operations in any one of the methods described in the foregoing method implementations. The computer includes a user device.

A computer program product is further provided in implementations of the disclosure. The computer program product includes a non-transitory computer-readable storage medium storing computer programs. The computer programs are operable to enable a computer to perform part or all of the operations described in the method in any one of the methods described in the foregoing method implementations. The computer program product may be a software installation package. The computer includes a user device.

It is to be noted that for the sake of simplicity, the foregoing method implementations are described as a series of action combinations. However, it will be appreciated by those skilled in the art that the disclosure is not limited by the sequence of actions described. According to the disclosure, some steps may be performed in other orders or simultaneously. Besides, it will be appreciated by those skilled in the art that the implementations described in the specification are preferred implementations, and the actions and modules involved are not necessarily essential to the disclosure.

In the foregoing implementations, the description of each implementation has its own emphasis. For the parts not described in detail in one implementation, reference may be made to related descriptions in other implementations.

In several implementations provided in the disclosure, it will be appreciated that the apparatuses disclosed may also be implemented in various other manners. For example, the above apparatus implementations are merely illustrative, e.g., the division of units is only a division of logical functions, and there may exist other manners of division in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interfaces, apparatuses, or units, and may be electrical, or otherwise.

Units illustrated as separated parts may or may not be physically separated. Components or parts displayed as units may or may not be physical units, and may reside at one location or may be distributed to multiple network units. Part of or all of the units may be selectively adopted according to practical needs to achieve desired objectives of the solutions of implementations.

In addition, various functional units described in various implementations of the disclosure may be integrated into one processing unit or may be presented as a number of physically separated units, and two or more units may be integrated into one unit. The integrated unit may be implemented by a form of hardware or a software functional unit.

If the integrated units are implemented as software functional units and sold or used as standalone products, they may be stored in a computer readable memory. According to such an understanding, the essential technical solution, or the portion that contributes to the related art, or all or part of the technical solution of the disclosure may be expressed as software products. The computer software products can be stored in a memory and may include multiple instructions that, when executed, can cause a computing device (e.g., a personal computer, a server, a network device, etc.) to execute all or part of steps of the methods described in various implementations of the disclosure. The above memory may include various kinds of media that can store program codes, such as a universal serial bus (USB) flash disk, an ROM, an RAM, a mobile hard disc, a magnetic disk, or an optical disk.

It will be understood by those of ordinary skill in the art that all or part of the steps of the various methods in the implementations described above may be accomplished by means of a program to instruct associated hardware, and the program may be stored in a computer-readable memory, which may include a flash disk, an ROM, an RAM, a magnetic disk, or an optical disk.

The above implementations in the disclosure are introduced in detail. Principles and implementation manners of the disclosure are elaborated with specific implementations herein. The illustration of implementations above is only used to help understanding of methods and core ideas of the disclosure. At the same time, for those of ordinary skill in the art, according to ideas of the disclosure, there will be changes in the specific implementation manners and application scope. In summary, contents of this specification should not be understood as limitation on the disclosure.

1. A method for transmission configuration indicator (TCI) state determination, comprising:
receiving higher-layer configuration information;
determining N control resource sets (CORESETs) and at least one TCI state of each of the N CORESETs based on the higher-layer configuration information, N being a positive integer;
determining a target CORESET from the N CORESETs; and
determining a target TCI state from at least one TCI state of the target CORESET.

2. The method of claim 1, wherein the target TCI state is used for determining a target quasi co-location (QCL) assumption.

3. The method of claim 2, wherein the target QCL assumption is used for aperiodic channel state information-reference signal (AP CSI-RS) transmission and/or for physical downlink shared channel (PDSCH) transmission.

4. The method of claim 1, wherein the target TCI state is used for determining a path loss reference signal (PL-RS) and/or a beam.

5. The method of claim 4, wherein the beam comprises at least one of:
a beam for physical uplink control channel (PUCCH) transmission;
a beam for physical uplink shared channel (PUSCH) transmission;
a beam for sounding reference signal (SRS) transmission;
a beam for AP CSI-RS transmission; or
a beam for PDSCH transmission.

6. The method of claim 4, wherein the PL-RS comprises at least one of:
a PL-RS for determining a PL of PUCCH transmission power;
a PL-RS for determining a PL of PUSCH transmission power; or
a PL-RS for determining a PL of SRS transmission power.

7. The method of claim 2, wherein the target CORESET is a CORESET with a lowest CORESET identifier (ID) among the N CORESETs.

8. The method of claim 7, wherein the target CORESET has at least two TCI states.

9. The method of claim 8, wherein
the target TCI state is a first TCI state among the at least two TCI states of the target CORESET;
the target TCI state is a last TCI state among the at least two TCI states of the target CORESET;
the target TCI state is a TCI state with a lowest TCI state ID among the at least two TCI states of the target CORESET; or
the target TCI state is a TCI state with a highest TCI state ID among the at least two TCI states of the target CORESET.

10. The method of claim 2, wherein the target CORESET is a CORESET with a lowest CORESET ID among M reference CORESETs, each of the reference CORESETs is a CORESET with one TCI state among the N CORESETs, and M is a positive integer and less than or equal to N.

11. The method of claim 2, wherein the target QCL assumption is used for transmitting a physical downlink control channel (PDCCH) candidate.

12. The method of claim 11, wherein the target CORESET is a CORESET corresponding to the PDCCH candidate among the N CORESETs.

13. The method of claim 12, wherein the target CORESET has at least two TCI states.

14. The method of claim 13, wherein
the target TCI state is a first TCI state among the at least two TCI states of the target CORESET;
the target TCI state is a last TCI state among the at least two TCI states of the target CORESET;
the target TCI state is a TCI state with a lowest TCI state ID among the at least two TCI states of the target CORESET; or
the target TCI state is a TCI state with a highest TCI state ID among the at least two TCI states of the target CORESET.

15-28. (canceled)

29. A terminal device comprising:
a communication interface;
a processor coupled to the communication interface; and
a memory configured to store a computer program;
the processor being configured to execute the computer program to cause the terminal device to:
receive higher-layer configuration information;
determine N control resource sets (CORESETs) and at least one TCI state of each of the N CORESETs based on the higher-layer configuration information, N being a positive integer;
determine a target CORESET from the N CORESETs; and
determine a target TCI state from at least one TCI state of the target CORESET.

30. The terminal device of claim 29, wherein the target TCI state is used for determining a target quasi co-location (QCL) assumption.

31. The terminal device of claim 30, wherein the target QCL assumption is used for aperiodic channel state information-reference signal (AP CSI-RS) transmission and/or for physical downlink shared channel (PDSCH) transmission.

32. The terminal device of claim 29, wherein the target TCI state is used for determining a path loss reference signal (PL-RS) and/or a beam.

33. The terminal device of claim 32, wherein the beam comprises at least one of:
a beam for physical uplink control channel (PUCCH) transmission;
a beam for physical uplink shared channel (PUSCH) transmission;
a beam for sounding reference signal (SRS) transmission;
a beam for AP CSI-RS transmission; or
a beam for PDSCH transmission.

34-58. (canceled)

59. A non-transitory computer-readable storage medium storing a computer program, the computer program being executed by a processor of a terminal device to cause the terminal device to perform:
receiving higher-layer configuration information;
determining N control resource sets (CORESETs) and at least one TCI state of each of the N CORESETs based on the higher-layer configuration information, N being a positive integer;
determining a target CORESET from the N CORESETs; and
determining a target TCI state from at least one TCI state of the target CORESET.

60. (canceled)
